(19) United States
(12) Patent Application Publication
(10) Pub. No.: US 2025/0117182 A1
(43) Pub. Date: Apr. 10, 2025

(54) CONTROLLING METHOD AND APPARATUS BASED ON EXTENDED REALITY, ELECTRONIC DEVICE, AND STORAGE MEDIUM

(71) Applicant: Beijing Zitiao Network Technology Co., Ltd., Beijing (CN)

(72) Inventors: Jia GUO, Beijing (CN); Jianhang SUN, Beijing (CN); Ziyuan LIU, Beijing (CN)

(21) Appl. No.: 18/909,273

(22) Filed: Oct. 8, 2024

(30) Foreign Application Priority Data
Oct. 8, 2023 (CN) 202311295740.8

(51) Int. Cl. G06F 3/16; G06T 19/00

(52) U.S. Cl. CPC G06F 3/16; G06T 19/006

(57) ABSTRACT

The disclosure provides a controlling method and apparatus based on extended reality, an electronic device, and a storage medium. The controlling method based on extended reality includes: determining a first audio in a real space in response to a first operation event of a current user; determining a first position in an extended reality space in response to a second operation event of the current user; and playing the first audio by taking the first position as a sound source position of the first audio in the extended reality space.

### CROSS-REFERENCE TO RELATED APPLICATION(S)

This application claims priority to Chinese Application No. 202311295740.8 filed in Oct. 8, 2023, and titled “CONTROLLING METHOD AND APPARATUS BASED ON EXTENDED REALITY, ELECTRONIC DEVICE, AND STORAGE MEDIUM”, the disclosure of which is incorporated herein by reference in its entity.

### FIELD

The disclosure relates to the technical field of computers, in particular to a controlling method and apparatus based on extended reality, an electronic device, and a storage medium.

### BACKGROUND

Extended reality includes virtual reality, augmented reality, mixed reality, etc. The augmented reality is an extension of virtual reality technology, and can augment a sense of reality of a user by presenting a virtual scenario in a real one. The mixed reality refers to coexistence and real-time interaction of physical entities and digital objects in a new environment combining real and virtual worlds.

### SUMMARY

The disclosure provides a controlling method and apparatus based on extended reality, an electronic device, and a storage medium.

The disclosure adopts the following technical solution:

In some examples, the disclosure provides a controlling method based on extended reality. The controlling method based on extended reality includes:
determining a first audio in a real space in response to a first operation event of a current user;
determining a first position in an extended reality space in response to a second operation event of the current user; and
playing the first audio by taking the first position as a sound source position of the first audio in the extended reality space.

In some examples, the disclosure provides a controlling method based on extended reality. The method includes:
determining a selected object in a real space in response to a first gesture operation;
determining a target position in an extended reality space based on a line of sight of a current user; and
adding the selected object to the target position in response to a second gesture operation.

In some examples, the disclosure provides a controlling apparatus based on extended reality. The controlling apparatus based on extended reality includes:
an obtaining unit configured to determine a selected object in a real space in response to a first gesture operation; and
a controlling unit configured to determine a target position in an extended reality space based on a line of sight of a current user; where
the controlling unit is further configured to add the selected object to the target position in response to a second gesture operation. In some examples, the disclosure provides a controlling apparatus based on extended reality. The controlling apparatus based on extended reality includes:
an obtaining unit configured to determine a first audio in a real space in response to a first operation event of a current user; and
a controlling unit configured to determine a first position in an extended reality space in response to a second operation event of the current user; where
the controlling unit is further configured to play the first audio by taking the first position as a sound source position of the first audio in the extended reality space.

In some examples, the disclosure provides an electronic device. The electronic device includes: at least one memory and at least one processor; where
the memory is configured to store program codes, and the processor is configured to execute the method described above by calling the program codes stored in the memory.

In some examples, the disclosure provides a computer-readable storage medium. The computer-readable storage medium is configured to store program codes, where the program codes are configured to cause a processor to execute the method described above when run by the processor.

According to the controlling method based on extended reality provided by the example of the disclosure, the first audio selected by the current user is selected and put at the first position selected by the current user in the extended display space. In this way, the current user can directionally capture an audio in the real space and generate a spatial audio in the extended reality space. Thus, the user is provided with a more realistic audio experience in the extended reality space, and a sense of reality of the user is improved.

### BRIEF DESCRIPTION OF THE DRAWINGS

The above and other features, advantages and aspects of examples of the disclosure will become more apparent with reference to accompanying drawings and in conjunction with the following specific embodiments. Throughout the accompanying drawings, the same or similar reference numerals indicate the same or similar elements. It should be understood that the accompanying drawings are illustrative and parts and elements are not necessarily drawn to scale.

FIG. 1 is a schematic diagram of using an extended reality device according to an example of the disclosure.

FIG. 2 is a schematic diagram of a virtual field of view of an extended reality device according to an example of the disclosure.

FIG. 3 is a flowchart of a controlling method based on extended reality according to an example of the disclosure.

FIGS. 4-7 are schematic diagrams of a controlling method based on extended reality according to examples of the disclosure.

FIG. 8 is a schematic diagram of using an extended reality device according to an example of the disclosure.

FIG. 9 is a schematic structural diagram of an electronic device according to an example of the disclosure.

### DETAILED DESCRIPTION OF EMBODIMENTS

It can be understood that before using the technical solutions disclosed in examples of the disclosure, a user should be informed of a type, a use range, a use scenario, etc. of personal information involved in the disclosure in an appropriate method according to relevant laws and regulations and be authorized by the user.

For example, in response to receiving an active request from the user, prompt information is sent to the user to clearly remind the user of the fact that a requested operation requires obtaining and using the personal information of the user. Thus, the user can independently determine, according to the prompt information, whether to provide personal information for software or hardware such as an electronic device, an application, a server or a storage medium that executes the operation of the technical solution of the disclosure.

As an optional but non-limitative implementation, in response to receiving the active request from the user, the prompt information may be sent to the user through, for example, a pop-up window. In the pop-up window, the prompt information may be presented in text. In addition, a selection control may be carried in the pop-up window for the user to select “yes” or “no” when determining whether to provide the personal information for the electronic device.

It can be understood that the above process of notifying and obtaining authorization of the user is merely illustrative, and does not limit an implementation of the disclosure. Other methods satisfying relevant laws and regulations may also be applied to the implementation of the disclosure.

It can be understood that the data involved in this technical solution (including but not limited to the data, obtaining or use of the data) should comply with the requirements of corresponding laws, regulations and relevant provisions.

The examples of the disclosure will be described below in more detail with reference to the accompanying drawings. Although some examples of the disclosure are shown in the accompanying drawings, it should be understood that the disclosure can adopt various implementations and should not be constructed to be limited to the examples set forth herein. On the contrary, these examples are provided for the convenience of more thorough and complete understanding of the disclosure. It should be understood that the accompanying drawings and the examples of the disclosure are merely used for illustration rather than limitation to the protection scope of the disclosure.

It should be understood that steps described in a method embodiment of the disclosure can be executed in and/or parallel. Further, the method embodiment can include an additional step and/or omit a shown step, which does not limit the scope of the disclosure.

As used herein, the terms “comprise”, “include” and their variations are open-ended, that is, “comprise but not limited to” and “include but not limited to”. The term “based on” indicates “at least partially based on”. The term “an example” indicates “at least one example”. The term “another example” indicates “at least another one example”. The term “some examples” indicates “at least some examples”. Related definitions of other terms will be given in the following description.

It should be noted that concepts such as “first” and “second” mentioned in the disclosure are merely used to distinguish different apparatuses, modules or units, rather than limit an order or interdependence of functions executed by these apparatuses, modules or units.

It should be noted that a modification with “a” and “an” mentioned in the disclosure is illustrative rather than limitative, and should be understood by those skilled in the art as “one or more” unless otherwise definitely indicated in the context.

A name of messages or information exchanged among a plurality of apparatuses in the embodiment of the disclosure is merely used for illustration rather than limitation to the scope of these messages or information.

A solution provided by the example of the disclosure will be described below in detail with reference to the accompanying drawings.

The extended reality (XR) technology in one or more examples of the disclosure may be mixed reality technology, extended reality technology and virtual reality technology. The extended reality technology can combine reality and virtuality through computers, so as to provide a user with an extended reality space for human-computer interaction. In the extended reality space, the user can perform social interaction, entertainment, study, work, telecommuting, creation of a user generated content (UGC), etc. through an extended reality device such as a head mount display (HMD).

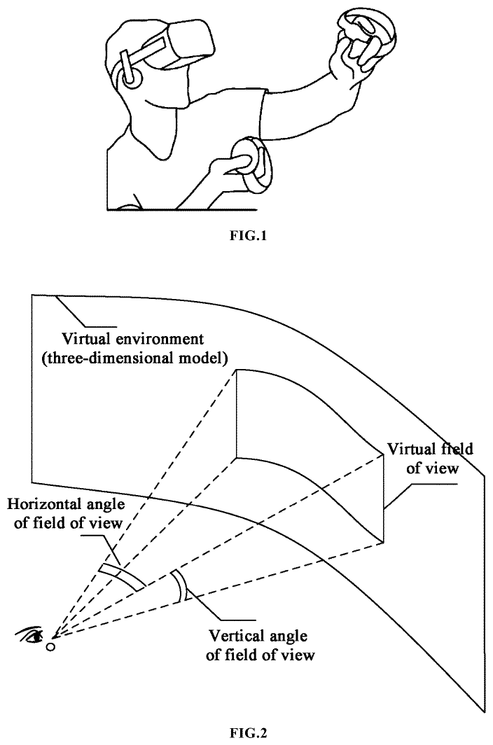

With reference to FIG. 1, the user may enter the extended reality space through the extended reality device such as head-mounted glasses, and control an avatar thereof to perform social interaction with avatars controlled by other users, entertainment, study, telecommuting, etc. in the extended reality space.

In an example, in the extended reality space, the user may implement a related interaction operation through a controller. The controller may be a handle, for example, the user controls related operations by operating keys of the handle. It is clear that in other examples, an object in the extended reality device may be controlled through a gesture, a voice or a multi-modal control manner instead of using a controller.

The extended reality device described in the example of the disclosure may include, but is not limited to, the following types:

A computer-side extended reality device uses a computer to perform related computations and data output of an extended reality function. The external computer-side extended reality device uses data output through the computer to achieve an extended reality effect.

A mobile extension device supports setting of a mobile terminal (such as a smart phone) in various methods (such as a head-mounted display with a special clamping slot). Through a wired or wireless connection to the mobile terminal, the mobile terminal performs related computations of an extended reality function and outputs data to the mobile extended reality device. For example, an extended reality video is watched through an application (App) of the mobile terminal.

An all-in-one extended reality device has a processor for performing related computations of the extended reality function, has independent extended reality input and output functions accordingly, and does not need to be connected to the computer side or the mobile terminal. Thus, a high degree of freedom of use is achieved.

It is clear that an implementation form of the extended reality device is not limited to the form described above, and can be further miniaturized or enlarged as needed.

The extended reality device is equipped with a posture detection sensor (such as a nine-axis sensor) to detect a posture change of the extended reality device in real time. If the user wears the extended reality device, a real-time posture of a head will be transmitted to the processor when the posture of the head of the user head changes, and a gaze point of the user in an extended reality space environment accordingly. According to the gaze point, an image, within a gaze range (a virtual field of view) of the user, in a three-dimensional model of the extended reality space environment is computed and displayed on a display screen, thus providing an immersive experience of watch that seems to be in a real environment.

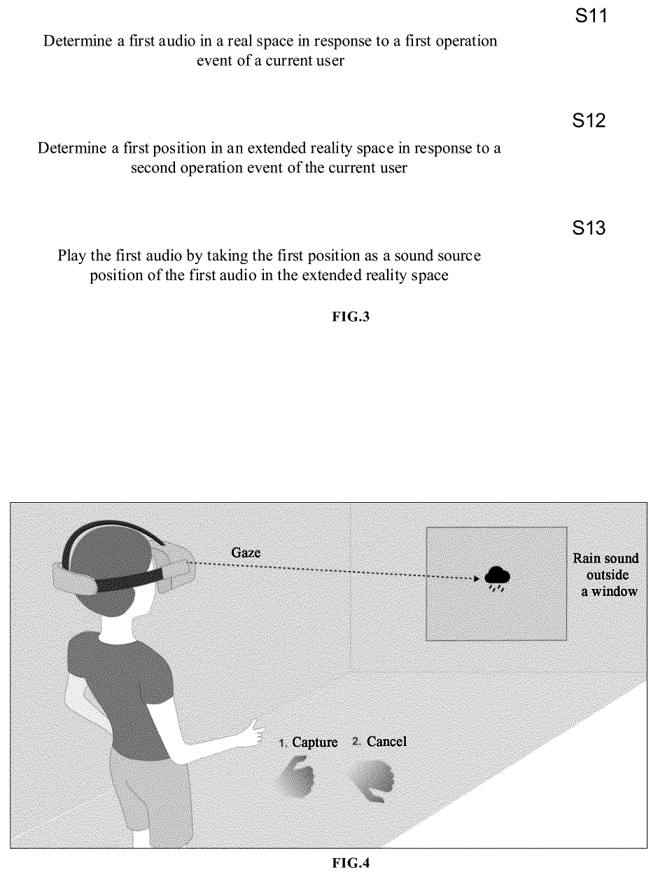

FIG. 2 shows an optional schematic diagram of a virtual field of view of an extended reality device according to some examples of the disclosure. A horizontal angle of field of view and a vertical angle of field of view are used to describe distribution ranges of the virtual field of view in the virtual environment, the vertical angle of field of view is used to denote a vertical distribution range, and the horizontal angle of field of view is used to denote a horizontal distribution range. The user may always perceive, with eyes, an image located in the virtual field of view in the extended reality space through lenses. It can be understood that the larger the angle of field of view is, the greater a size of the virtual field of view is, and the user can perceive a larger area of the extended reality space. The angle of field of view denotes the distribution range of angle of view for perceiving the environment through the lenses. For example, the angle of field of view of the extended reality device denotes a distribution range of an angle of view of human eyes when the extended reality space environment is perceived through the lens of the extended reality device. For example, for a mobile terminal equipped with a camera, an angle of field of view of the camera denotes a distribution range of an angle of view when the camera perceives and photographs the real environment.

As shown in FIG. 3, FIG. 3 is a flowchart of a controlling method based on extended reality according to an example of the disclosure. The controlling method based on extended reality includes:

S11. A first audio in a real space is determined in response to a first operation event of a current user.

In some examples, the method provided by the disclosure may be used for a terminal. The terminal may be an extended reality device. The current user may be a user using the terminal. The first operation event may include one or more operations, and may include one or more of an eye fixation operation, a gesture operation or a voice operation. The first audio is an audio selected by the current user in the real space, and may be an environmental sound, such as a rain sound, birdsong in a natural environment, and a music sound played by an electronic device in the real environment. For example, the current user may record the rain sound as the first audio by watching rain outside a window. After the first audio is determined, the first audio may be automatically stored in a sound library as a file. The stored first audio may be renamed and retrieved from the sound library. The audios in the sound library can be manually or automatically classified into as follows: a human voice, an animal voice, a vehicle voice, a natural voice, etc. When the first audio is stored in the sound library, the current user may be automatically prompted to select a class of the first audio. Alternatively, the terminal executing the method may automatically recognize a type of the first audio and classify the first audio by means of a neural network algorithm, for example. The first audio may be sent to the server for being classified, and returned to the terminal after being classified by the server. After the first audio is determined, the current user may add an annotation to the first audio by executing an annotation operation.

S12. A first position in an extended reality space is determined in response to a second operation event of the current user.

In some examples, the second operation event may include one or more operations. The extended reality space may be a pure virtual space, or a space combining virtual and reality. The first position may be one or more positions in the extended reality space. The first position may be a position located on a thing, such as a sound box, a piano, a guitar, or may be located on a creature, such as a bird and man. In some examples, the first audio may be selected through a gesture. The first audio may be adsorbed in a position at which the current user gazes, such as a floor ground, a wall, a ceiling, furniture or a creature, in the form of, for example, a note. A position where the note is located is the first position.

S13. The first audio is played by taking the first position as a sound source position of the first audio in the extended reality space.

In some examples, the first position is used as the sound source position of the first audio, and then the first audio is played at the sound source position. When a plurality of first positions are provided, a plurality of sound source positions are provided accordingly, and a stereo sound may be formed in this case.

In some examples of the disclosure, obtaining and putting of the first audio are designed. The current user may directionally capture the audio from the real space, and put the captured first audio in the extended reality space, so as to generate a spatial audio in the extended reality space. Thus, the user is provided with a more realistic audio experience in the extended reality space, and a sense of reality of the user is improved.

In some examples, the first position may be deleted. After some of the first positions are deleted, the sound source positions of the first audio are reduced. After all of the first positions are deleted, the first audio may no longer be played. For the first audio being played, the first audio may be stopped from being played by executing a stop operation.

In some examples of the disclosure, the step that the first audio is played by taking the first position as a sound source position of the first audio in the extended reality space includes: attribute information of a first object that is related to the first audio in the extended reality space is determined based on the first position; and the first audio is played based on the attribute information of the first object by taking the first position as the sound source position. An audio effect of the first audio is related to the attribute information of the first object.

In some examples, the audio effect of the first audio is related to the first audio itself as well as the attribute information of the first object. The first object is related to the first audio, and affects the audio effect of the first audio accordingly. For example, the first object may include an environment where the first position is located, and the attribute information of the first object may include the environmental attribute of the environment where the first position is located in the extended reality space. For example, if there is a virtual wind direction in the environment where the first position is located, the environmental attribute includes the virtual wind direction, then the audio effect of the first audio may change as the virtual wind direction changes, and the first position may also change within a preset amplitude range as the virtual wind direction changes. Thus, the audio effect of the first audio has a dynamic feeling corresponding to the virtual wind direction. For example, if the environmental attribute indicates an indoor or outdoor environment, the audio effect of the first audio can be adjusted to be more like the audio made indoors (such as with echoes) or made outdoors. The first object may include a thing where the first position is located, and an attribute of the first object includes a material attribute and/or a thing type attribute of the thing where the first position is located. For example, when the first position is located on a music box or piano, the audio effect varies, and the audio effect of the first audio may be automatically adjusted according to the thing type attribute of the music box or the piano. The music box may be made of wood or steel. The audio effect of the first audio may automatically change corresponding to the material of wood or steel. The audio effect can be automatically adjusted, such that the first audio is similar to the audio of the thing type attribute and is similar to the audio that can be emitted by the material attribute. The first object may include a creature where the first position is located, and an attribute of the first object may include an emotional attribute and/or a biological species attribute of the creature where the first position is located. The emotional attribute of the creature may include joy, anger, sorrow and happiness, and the biological species attribute may include man, a bird, etc. When man are happy, the audio effect of the first audio may be light, and when man are sorrowful, the audio effect of the first audio may be slightly soothing. If the creature where the first audio is located is man, the audio effect of the first audio may be adjusted to be like a sound made by man. If the creature where the first audio is located is the bird, the audio effect of the first audio may be adjusted to be like a sound made by the bird. In addition, if the thing or the creature where the first position is located moves, the sound source position may also move accordingly. In this example, the first audio played in the extended reality environment conforms to the attribute information of the first object, and a playing effect of the first audio is more realistic and better.

In some examples of the disclosure, after the step that a first audio in a real space is determined and before responding to a second operation event of the current user, the method further includes: the determined first audio in the real space is filtered and an interfering sound or an audio of an object specified by the current user is removed from the first audio.

In some examples, there may be interference when the first audio is obtained. For example, when the first audio is a rain sound outside the window, a vehicle sound, a human voice or bark of a pet outside the window may also be recorded. Thus, the determined first audio may be filtered to remove other audios and merely obtain the audio that the current user wants. The current user may specify the object, such as the pet, and then the audio of the specified object is removed from the first audio. Thus, the interference of noise in the first audio can be avoided.

In some examples of the disclosure, before the step that a first audio in a real space is determined in response to a first operation event of a current user, the method further includes: an image of the real space is obtained, and a point cloud map is generated based on the image of the real space; and the real space is calibrated based on the point cloud map, and corresponding coordinates, in the extended reality space, of a thing in the real space are determined.

In some examples, the image of the real space may be shot through a camera and a depth camera of the terminal. The point cloud map may be generated based on things in the real space. The point cloud map describes an arrangement of the things in the real space, and then the objects in the real space are calibrated. A calibration process may include: a size and a shape of the thing in the real space are determined, then corresponding coordinates, in the extended reality space, of the thing in the real space are determined based on a calibration result, and the thing in the real space is mapped to the extended reality space. In this way, the things in the real space can have corresponding positions in the extended reality space and can be displayed in the extended reality space.

In some examples of the disclosure, the step that a first audio in a real space is determined in response to a first operation event of a current user includes: a target object in the real space is determined in response to at least one of an eye fixation operation, a gesture operation or a voice operation by the current user, and the first audio is determined based on the target object.

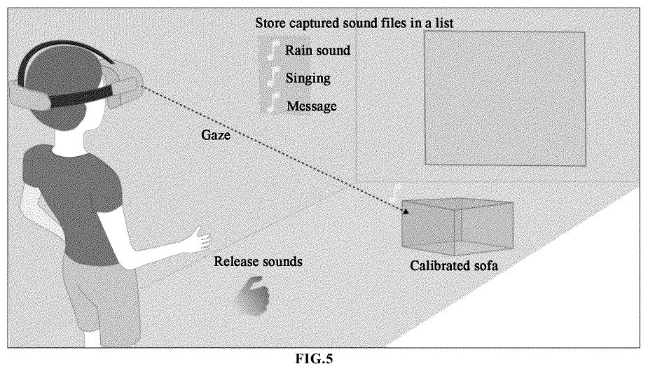

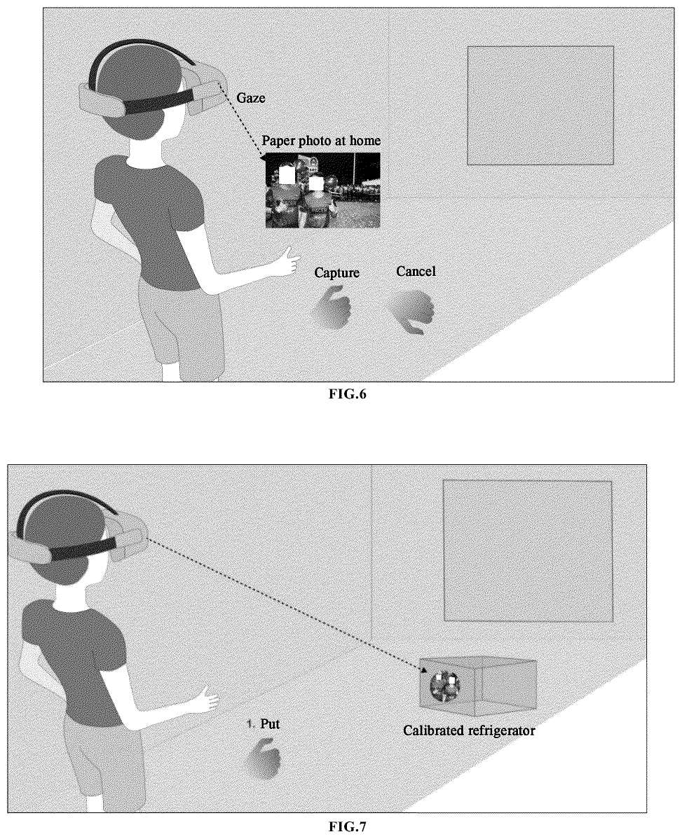

In some examples, the target object is an object related to the first audio, and may be an object that generates the first audio. For example, if the target object is the piano, the first audio is a current piano sound of the piano, and if the target object is rain, the first audio is the rain sound. As shown in FIG. 4, the current user may use a head-mounted terminal. The head-mounted terminal detects the eye fixation operation of the user, the user gazes at the rain outside the window, and the rain outside the window is taken as the target object. Then, the first audio is determined and collected by executing a capture or cancel gesture. After the first audio is determined, as shown in FIG. 5, the first audio may be classified according to options such as “a rain sound”, “singing” or “a message”. The first position may be selected through at least one of the eye fixation operation, the gesture operation or the voice operation. The first audio may be put on a sofa as the first position by gazing at the calibrated sofa and then releasing the sound.

In some examples of the disclosure, the step that a target object in the real space is determined in response to at least one of an eye fixation operation, a gesture operation or a voice operation by the current user includes: scores of second objects at which the current user glances are determined in response to the eye fixation operation by the current user, and the target object is determined based on the scores of the second objects at which the current user glances. The score of the second object changes as the current user looks at the second object or looks away from the second object.

In some examples, the current user may select the target object by executing the eye fixation operation. Since a field of view of the current user may be erratic, scores may be set for the second objects. For example, the current user glances at a plurality of second objects, and the scores of the second objects may be set to 100 initially. After the current user looks away from the second object, the score automatically decreases, and when the current user gazes at the second object, the score increases or remains unchanged. Finally, the second object that has the highest score is selected as the target thing. Alternatively, the initial score is 0, the longer the current user gazes at the second thing, the higher the score is. When the current user looks away from the second thing, the score of the second thing remains unchanged or decreases.

In some examples of the disclosure, the step that a target object in the real space is determined in response to at least one of an eye fixation operation, a gesture operation or a voice operation by the current user includes: an object under a current gaze through the eye fixation operation by the current user is determined as the target object in response to the voice operation or the gesture operation by the current user under the condition that a meaning of the voice operation or the gesture operation indicates that the current user is to determine the target object.

In some examples, the current user may indicate a current wish to determine the target object by executing the voice operation or the gesture operation, and the object determined through the eye fixation operation is the target object in this case. For example, the current user looks at a pet and then utters a voice “enter it”, in which “it” indicates an intention of the current user without explicitly stating that the target object is this pet.

In some examples of the disclosure, the method further includes: a first image or a first text in the real space is determined in response to a third operation event of the current user. A second position in the extended reality space is determined in response to a fourth operation event of the current user; and the first image or the first text is displayed at the second position of the extended reality space.

In some examples, the third operation event and the fourth operation event may also independently include at least one of the eye fixation operation, the gesture operation or the voice operation by the current user. As shown in FIG. 5, the current user may look at a paper photo at home and then execute a capture gesture, and the paper photo is determined as the first image. Similarly, the current user may look at a paragraph of text and then execute the capture gesture, so as to determine that this paragraph of text as the first text. The first image or first text determined may be automatically stored, classified and renamed. Then, as shown in FIG. 7, the current user may gaze at the second position (a refrigerator surface calibrated in FIG. 7) and then execute a gesture operation of putting, so as to put the first image or the first text at the second position for being displayed. The first image or the first text displayed at the second position may be subjected to editing operations such as zooming-in, zooming-out, cropping and cutout.

In some examples of the disclosure, the method further includes: a virtual thing is controlled to execute a corresponding response action in response to determining that the virtual thing in the extended reality space is in contact with an physical thing in the real space. In some examples, the thing in the real space may be displayed in the extended reality space, and may interact with the virtual thing in the extended reality space. For example, the virtual object is a virtual sphere, and the virtual sphere bounces when colliding with the thing in the real space. Thus, interaction between the virtual object and the real thing is implemented, and realistic and interest effects are improved.

In some examples of the disclosure, the first audio specified by the user may be obtained by directionally obtaining the audio in the real space and classified. In addition, the first audio may be released to the first position specified by the current user in the extended reality space, and the first audio played conforms to the attribute information of the extended reality space. Thus, a realistic high-quality audio is provided for the current user, the realistic and interest effects are improved, and immersion and interactive experiences of the user are enhanced.

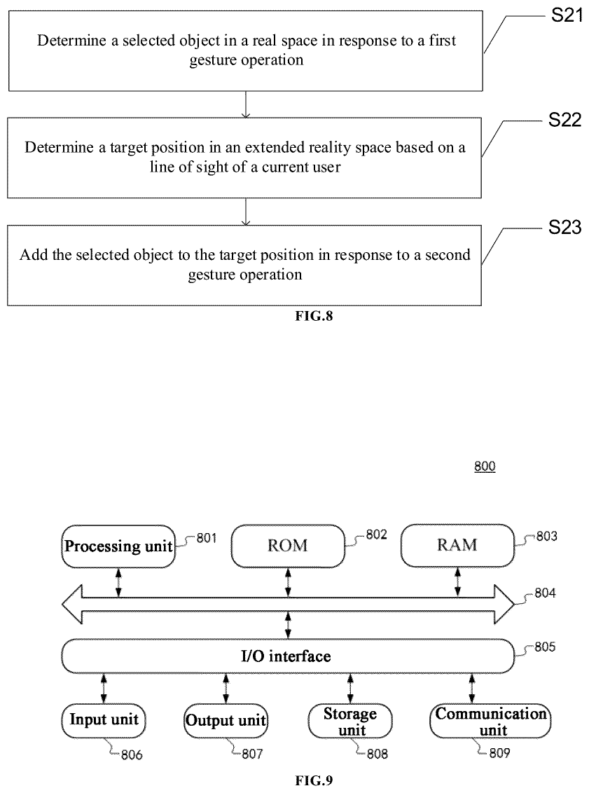

In some examples of the disclosure, a controlling method based on extended reality is further provided. The technical features and descriptions of any example described above of the disclosure can also be used in any example below without conflict. As shown in FIG. 8, the method includes:

S21. A selected object in a real space is determined in response to a first gesture operation;

In some examples, the method provided by the disclosure may be used for a terminal. The terminal may be an extended reality device. The current user may be a user using the terminal. The first gesture operation may include one or more gesture operations. The selected object includes one or more of an audio, a picture, a text or a thing. The selected object is an object in the real space selected through the first gesture operation, and may be the first audio in the above example. After the first audio is determined, the first audio may be automatically stored in a sound library as a file. The stored first audio may be renamed and retrieved from the sound library. The audios in the sound library can be manually or automatically classified into as follows: a human voice, an animal voice, a vehicle voice, a natural voice, etc. When the first audio is stored in the sound library, the current user may be automatically prompted to select a class of the first audio. Alternatively, the terminal executing the method may automatically recognize a type of the first audio and classify the first audio by means of a neural network algorithm, for example. The first audio may be sent to the server for being classified, and returned to the terminal after being classified by the server. After the first audio is determined, the current user may add an annotation to the first audio by executing an annotation operation.

S22. A target position is determined in an extended reality space based on a line of sight of a current user.

In some examples, the target position may be the first position described above. A sensor may detect the line of sight of eyes of the user who is currently using the terminal, and the line of sight of the eyes may be used for path navigation to determine a destination position.

S23. The selected object is added to the target position in response to a second gesture operation.

In some examples, the second gesture operation includes one or more gesture operations. When the selected object is the first audio, the target position is used as the sound source position of the first audio, and then the first audio is played at the sound source position. When a plurality of target positions are provided, a plurality of sound source positions are provided accordingly, and a stereo sound may be formed in this case. When the selected object is the picture or the text, the selected object may be the first image or the first text described above, and the related description of the first image or the first text is also applicable to this example.

In some examples of the disclosure, the current user may directionally capture the object in the real space through the first gesture operation. Based on the selected object captured, the user may navigate a path with the line of sight of the eyes and put the object in the extended reality space. Putting in the extended reality space can be implemented through the second gesture operation, thus providing the user with a more convenient interaction experience of selecting and positioning the object.

In some examples, the selected object is the first audio, and the target positions may be deleted. After some of the target positions are deleted, the sound source positions of the first audio are reduced. After all of the target positions are deleted, the first audio may no longer be played. For the first audio being played, the first audio may be stopped from being played by executing a stop operation.

In some examples of the disclosure, under the condition that the selected object is a first audio in the real space, the step that the selected object is added to the target position in response to a second gesture operation includes: attribute information of a first object that is related to the first audio in the extended reality space is determined based on the target position; and the first audio is played based on the attribute information of the first object by taking the target position as a sound source position. An audio effect of the first audio is related to the attribute information of the first object.

In some examples, the audio effect of the first audio is related to the first audio itself as well as the attribute information of the first object. The first object is related to the first audio, and affects the audio effect of the first audio accordingly. For example, the first object may include an environment where the target position is located, and the attribute information of the first object may include an environmental attribute of the environment where the target position is located in the extended reality space. For example, if there is a virtual wind direction in the environment where the target position is located, the environmental attribute includes the virtual wind direction, then the audio effect of the first audio may change as the virtual wind direction changes, and the target position may also change within a preset amplitude range as the virtual wind direction changes. Thus, the audio effect of the first audio has a dynamic feeling corresponding to the virtual wind direction. For example, if the environmental attribute indicates an indoor or outdoor environment, the audio effect of the first audio can be adjusted to be more like the audio made indoors (such as with echoes) or made outdoors. The target object may include a thing where the target position is located, and an attribute of the first object includes a material attribute and/or a thing type attribute of the thing where the target position is located. For example, when the target position is located on a music box or piano, the audio effect varies, and the audio effect of the first audio may be automatically adjusted according to the thing type attribute of the music box or the piano. The music box may be made of wood or steel. The audio effect of the first audio may automatically change corresponding to the material of wood or steel. The audio effect can be automatically adjusted, such that the first audio is similar to the audio of the thing type attribute and is similar to the audio that can be emitted by the material attribute. The first object may include a creature where the target position is located, and the attribute of the first object may include an emotional attribute and/or a biological species attribute of the creature where the target position is located. The emotional attribute of the creature may include joy, anger, sorrow and happiness, and the biological species attribute may include man, a bird, etc. When man are happy, the audio effect of the first audio may be light, and when man are sorrowful, the audio effect of the first audio may be slightly soothing. If the creature where the first audio is located is man, the audio effect of the first audio may be adjusted to be like a sound made by man. If the creature where the first audio is located is the bird, the audio effect of the first audio may be adjusted to be like a sound made by the bird. In addition, if the thing or the creature where the target position is located moves, the sound source position may also move accordingly. In this example, the first audio played in the extended reality environment conforms to the attribute information of the first object, and a playing effect of the first audio is more realistic and better.

In some examples of the disclosure, after the step that a selected object in a real space is determined and before the step that the selected object is added to the target position in response to a second gesture operation, the method further includes: the determined first audio in the real space is filtered and an interfering sound or an audio of an object specified by the current user are removed from the first audio.

In some examples of the disclosure, before the step that a selected object in a real space is determined in response to a first gesture operation, the method further includes: an image of the real space is obtained, and a point cloud map is generated based on the image of the real space; and the real space is calibrated based on the point cloud map, and corresponding coordinates, in the extended reality space, of a thing in the real space are determined.

In some examples, the image of the real space may be shot through a camera and a depth camera of the terminal. The point cloud map may be generated based on things in the real space. The point cloud map describes an arrangement of the things in the real space, and then the objects in the real space are calibrated. A calibration process may include: a size and a shape of the thing in the real space are determined, then corresponding coordinates, in the extended reality space, of the thing in the real space are determined based on a calibration result, and the thing in the real space is mapped to the extended reality space. In this way, the things in the real space can have corresponding positions in the extended reality space and can be displayed in the extended reality space.

In some examples of the disclosure, before the step that a selected object in a real space is determined in response to a first gesture operation, the method includes: a target object in the real space is determined in response to at least one of an eye fixation operation, a gesture operation or a voice operation by the current user, and determining the first audio based on the target object. The step that a selected object in a real space is determined in response to a first gesture operation includes: the first audio is determined based on the target object in response to the first gesture operation.

In some examples, the target object is an object related to the first audio, and may be an object that generates the first audio. For example, if the target object is the piano, the first audio is a current piano sound of the piano, and if the target object is rain, the first audio is the rain sound. As shown in FIG. 4, the current user may use a head-mounted terminal. The head-mounted terminal detects the eye fixation operation of the user, the user gazes at the rain outside the window, and the rain outside the window is taken as the target object. Then, the first audio is determined and collected by executing a capture or cancel gesture. After the first audio is determined, as shown in FIG. 5, the first audio may be classified according to options such as “a rain sound”, “singing” or “a message”.

In some examples of the disclosure, the step that a target object in the real space is determined in response to at least one of an eye fixation operation, a gesture operation or a voice operation by the current user includes: an object under a current gaze through the eye fixation operation by the current user is determined as the target object in response to the voice operation or the gesture operation by the current user under the condition that a meaning of the voice operation or the gesture operation indicates that the current user is to determine the target object.

In some examples, the current user may select the target object by executing the eye fixation operation. Since a field of view of the current user may be erratic, scores may be set for the second objects. For example, the current user glances at a plurality of second objects, and the scores of the second objects may be set to 100 initially. After the current user looks away from the second object, the score automatically decreases, and when the current user gazes at the second object, the score increases or remains unchanged. Finally, the second object that has the highest score is selected as the target thing. Alternatively, the initial score is 0, the longer the current user gazes at the second thing, the higher the score is. When the current user looks away from the second thing, the score of the second thing remains unchanged or decreases.

In some examples of the disclosure, the step that a target object in the real space is determined in response to at least one of an eye fixation operation, a gesture operation or a voice operation by the current user includes: an object under a current gaze through the eye fixation operation by the current user is determined as the target object in response to the voice operation or the gesture operation by the current user under the condition that a meaning of the voice operation or the gesture operation indicates that the current user is to determine the target object.

In some examples, the current user may indicate a current wish to determine the target object by executing the voice operation or the gesture operation, and the object determined through the eye fixation operation is the target object in this case. For example, the current user looks at a pet and then utters a voice “enter it”, in which “it” indicates an intention of the current user without explicitly stating that the target object is this pet.

In some examples of the disclosure, the method further includes: a virtual thing is controlled to execute a corresponding response action in response to determining that the virtual thing in the extended reality space is in contact with an physical thing in the real space. In some examples, the thing in the real space may be displayed in the extended reality space, and may interact with the virtual thing in the extended reality space. For example, the virtual object is a virtual sphere, and the virtual sphere bounces when colliding with the thing in the real space. Thus, interaction between the virtual object and the real thing is implemented, and realistic and interest effects are improved.

Some examples the disclosure further provide a controlling apparatus based on extended reality. The controlling apparatus based on extended reality includes:
an obtaining unit configured to determine a first audio in a real space in response to a first operation event of a current user; and
a controlling unit configured to determine a first position in an extended reality space in response to a second operation event of the current user; where
the controlling unit is further configured to play the first audio by taking the first position as a sound source position of the first audio in the extended reality space.

In some examples, the step that the first audio is displayed by taking the first position as a sound source position of the first audio in the extended reality includes:
attribute information of a first object that is related to the first audio in the extended reality space is determined based on the first position;
the first audio is played based on the attribute information of the first object by taking the first position as the sound source position; where
an audio effect of the first audio is related to the attribute information of the first object.

In some examples, the attribute information of the first object that is related to the first audio in the extended reality space includes any one of the following:
an environmental attribute of an environment where the first position is located in the extended reality space;
a material attribute and/or a thing type attribute of a thing where the first position is located; and
an emotional attribute and/or a biological species attribute of a creature where the first position is located.

In some examples, after determining a first audio in a real space and before responding to a second operation event of the current user, the controlling unit is further configured to:
filter the determined first audio in the real space and remove, from the first audio, an interfering sound or an audio of an object specified by the current user.

In some examples of the disclosure, before determining a first audio in a real space in response to a first operation event of a current user, the obtaining unit is further configured to: obtain an image of the real space, and generate a point cloud map based on the image of the real space; and calibrate the real space based on the point cloud map, and determine corresponding coordinates, in the extended reality space, of a thing in the real space.

In some examples, the step that a first audio in a real space is determined in response to a first operation event of a current user includes: a target object in the real space is determined in response to at least one of an eye fixation operation, a gesture operation or a voice operation by the current user, and the first audio is determined based on the target object.

In some examples, the step that a target object in the real space is determined in response to at least one of an eye fixation operation, a gesture operation or a voice operation by the current user includes: scores of second objects at which the current user glances are determined in response to the eye fixation operation by the current user, and the target object is determined based on the scores of the second objects at which the current user glances. The score of the second object changes as the current user looks at the second object or looks away from the second object.

Alternatively, an object under a current gaze through the eye fixation operation by the current user is determined as the target object in response to the voice operation or the gesture operation by the current user under the condition that a meaning of the voice operation or the gesture operation indicates that the current user is to determine the target object.

In some examples of the disclosure, the controlling unit is further configured to: determine a first image or a first text in the real space in response to a third operation event of the current user;
determine a second position in the extended reality space in response to a fourth operation event of the current user; and
display the first image or the first text at the second position of the extended reality space.

In some examples of the disclosure, the controlling unit is further configured to: control a virtual thing to execute a corresponding response action in response to determining that the virtual thing in the extended reality space is in contact with an physical thing in the real space.

Some examples the disclosure provide a controlling apparatus based on extended reality. The controlling apparatus based on extended reality includes:
an obtaining unit configured to determine a selected object in a real space in response to a first gesture operation; and
a controlling unit configured to determine a target position in an extended reality space based on a line of sight of a current user; where
the controlling unit is further configured to add the selected object to the target position in response to a second gesture operation.

The selected object includes one or more of an audio, a picture, a text or a thing.

In some examples, under the condition that the selected object is a first audio in the real space,
the step the selected object is added to the target position in response to a second gesture operation includes: attribute information of a first object that is related to the first audio in the extended reality space is determined based on the target position; and
the first audio is played based on the attribute information of the first object by taking the target position as a sound source position; where
an audio effect of the first audio is related to the attribute information of the first object.

In some examples, the attribute information of the first object that is related to the first audio in the extended reality space includes any one of the following:
an environmental attribute of an environment where the target position is located in the extended reality space;
a material attribute and/or a thing type attribute of a thing where the target position is located; and
an emotional attribute and/or a biological species attribute of a creature where the target position is located.

As for an apparatus example, since this example basically corresponds to the method example, reference can be made to partial description of the method example for relevant contents. The apparatus examples described above are merely illustrative, the modules described as separated modules can be physically separated, or not. Some or all modules may be selected according to actual needs to achieve the objectives of the solutions of the examples. What is described above can be understood and implemented by those skilled in the art without creative efforts.

The method and the apparatus of the disclosure are described above based on examples and application examples. In addition, the disclosure further provides an electronic device and a computer-readable storage medium. The electronic device and the computer-readable storage medium are described below.

With reference to FIG. 9, a schematic structural diagram of the electronic device 800 (for example, a terminal device or a server) applied to implementation of the example of the disclosure is shown. The terminal device in the example of the disclosure may include, but is not limited to, a mobile terminal such as a mobile phone, a notebook computer, a digital broadcast receiver, a personal digital assistant (PDA), a portable android device (PAD), a portable multimedia player (PMP), a vehicle-mounted terminal (such as a vehicle-mounted navigation terminal), and a fixed terminal such as a digital TV and a desktop computer. The electronic device shown in the figure is merely illustrative, and should not be constructed as limitation of any type to functions and application scopes of the example of the disclosure.

The electronic device 800 may include a processing unit 801 (for example, a central processing unit and a graphics processing unit), which may execute various appropriate actions and processing according to a program stored in a read-only memory (ROM) 802 or loaded from a storage unit 808 to a random access memory (RAM) 803. The RAM 803 may further store various programs and data required for the operation of the electronic device 800. The processing unit 801, the ROM 802, and the RAM 803 are connected to each other through a bus 804. An input/output (I/O) interface 805 is also connected to the bus 804.

Generally, the following apparatuses may be connected to the I/O interface 805: an input unit 806 including, for example, a touch screen, a touch pad, a keyboard, a mouse, a camera, a microphone, an accelerometer and a gyroscope, an output unit 807 including, for example, a liquid crystal display (LCD), a speaker and a vibrator, the storage unit 808 including, for example, a magnetic tape and a hard disk, and a communication unit 809. The communication unit 809 may allow the electronic device 800 to be in wireless or wired communication with other devices for data exchange. Although the electronic device 800 having various apparatuses is shown in the figure, it should be understood that not all the devices shown herein are required to be implemented or provided. More or fewer apparatuses may be alternatively implemented or provided.

Specifically, according to the example of the disclosure, a process described above with reference to the flowchart may be implemented as a computer software program. For example, the example of the disclosure includes a computer program product. The computer program product includes a computer program carried on a computer-readable medium, and the computer program includes program codes for executing the method shown in the flowchart. In such an example, the computer program may be downloaded and installed from the network through the communication unit 809, or installed from the storage unit 808, or installed from the ROM 802. When executed by the processing unit 801, the computer program executes the above functions defined in the method of the example of the disclosure.

It should be noted that the computer-readable medium described above in the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or their any combination. More specific examples of the computer-readable storage medium may include, but is not limited to, an electrical connection having one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or their any suitable combination. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is carried. This propagated data signal may have a plurality of forms, including but not limited to an electromagnetic signal, an optical signal or their any suitable combination. The computer-readable signal medium may further be any computer-readable medium other than the computer-readable storage medium, and the computer-readable signal medium may send, propagate or transmit a program used by or in combination with the instruction execution system, apparatus or device. A program code included in the computer-readable medium may be transmitted through any suitable medium, including but not limited to: a wire, an optical cable, a radio frequency (RF) medium, etc., or their any their suitable combination.

In some embodiments, a client side and a server may communicate by using any currently-known or future-developed network protocol such as the hypertext transfer protocol (HTTP), and may be interconnected to digital data communication (for example, a communication network) in any form or medium. Instances of the communication network include a local area network (“LAN”), a wide area network (“WAN”), internet work (for example, the Internet), an end-to-end network (for example, adhoc end-to-end network), and any currently-known or future-developed network.

The computer-readable medium may be included in the electronic device, or exist independently without being fitted into the electronic device.

The computer-readable medium carries one or more programs, and when executed by the electronic device, the one or more programs cause the electronic device to execute the method of the disclosure.

Computer program codes for executing the operations of the disclosure may be written in one or more programming languages or their combinations, and the programming languages include object-oriented programming languages including Java, Smalltalk and C++, and further include conventional procedural programming languages including “C” language or similar programming languages. The program codes may be completely executed on a computer of the user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various examples of the disclosure. In this regard, each block in the flowchart or block diagram may represent one module, one program segment, or some of codes that includes one or more executable instructions for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the example of the disclosure may be implemented by software or hardware. The name of the unit does not limit the unit itself in some cases.

The functions described above herein may be executed at least in part by one or more hardware logic components. For example, in a non-limitative mode, illustrative types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. More specific instances of the machine-readable storage medium may include an electrical connection based on one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or their any suitable combination.

According to one or more examples of the disclosure, a controlling method based on extended reality is provided. The controlling method based on extended reality includes:
a first audio in a real space is determined in response to a first operation event of a current user;
a first position in an extended reality space is determined in response to a second operation event of the current user; and
the first audio is played by taking the first position as a sound source position of the first audio in the extended reality space.

In the controlling method based on extended reality provided according to one or more examples of the disclosure, the step that the first audio is displayed by taking the first position as a sound source position of the first audio in the extended reality includes:
attribute information of a first object that is related to the first audio in the extended reality space is determined based on the first position;
the first audio is played based on the attribute information of the first object by taking the first position as the sound source position, where
an audio effect of the first audio is related to the attribute information of the first object.

In the controlling method based on extended reality provided according to one or more examples of the disclosure, the attribute information of the first object that is related to the first audio in the extended reality space includes any one of the following:
an environmental attribute of an environment where the first position is located in the extended reality space;
a material attribute and/or a thing type attribute of a thing where the first position is located; and
an emotional attribute and/or a biological species attribute of a creature where the first position is located.

In the controlling method based on extended reality provided according to one or more examples of the disclosure, after the step that a first audio in a real space is determined and before responding to a second operation event of the current user, the method further includes:
the determined first audio in the real space is filtered and an interfering sound or an audio of an object specified by the current user is removed from the first audio.

In the controlling method based on extended reality provided according to one or more examples of the disclosure, before the step that a first audio in a real space is determined in response to a first operation event of a current user, the method further includes:
an image of the real space is obtained, and a point cloud map is generated based on the image of the real space; and the real space is calibrated based on the point cloud map, and corresponding coordinates, in the extended reality space, of a thing in the real space are determined.

In the controlling method based on extended reality provided according to one or more examples of the disclosure, the step that a first audio in a real space is determined in response to a first operation event of a current user includes:
a target object in the real space is determined in response to at least one of an eye fixation operation, a gesture operation or a voice operation by the current user, and the first audio is determined based on the target object.

In the controlling method based on extended reality provided according to one or more examples of the disclosure, the step that a target object in the real space is determined in response to at least one of an eye fixation operation, a gesture operation or a voice operation by the current user includes:
scores of second objects at which the current user glances are determining in response to the eye fixation operation by the current user, and the target object is determined based on the scores of the second objects at which the current user glances; where the score of the second object changes as the current user looks at the second object or looks away from the second object; and
alternatively,
an object under a current gaze through the eye fixation operation by the current user is determined as the target object in response to the voice operation or the gesture operation by the current user under the condition that a meaning of the voice operation or the gesture operation indicates that the current user is to determine the target object.

According to one or more examples of the disclosure, the controlling method based on extended reality is provided. The method further includes:
a first image or a first text in the real space is determined in response to a third operation event of the current user;
a second position in the extended reality space is determined in response to a fourth operation event of the current user; and
the first image or the first text is displayed at the second position of the extended reality space.

According to one or more examples of the disclosure, the controlling method based on extended reality is provided. The method further includes:
a virtual thing is controlled to execute a corresponding response action in response to determining that the virtual thing in the extended reality space is in contact with an physical thing in the real space.

According to one or more examples of the disclosure, a controlling method based on extended reality is provided. The controlling method based on extended reality includes:
a selected object in a real space is determined in response to a first gesture operation;
a target position in an extended reality space is determined based on a line of sight of a current user; and
the selected object is added to the target position in response to a second gesture operation.

In the controlling method based on extended reality provided according to one or more examples of the disclosure, the selected object includes one or more of an audio, a picture, a text or a thing.

In the controlling method based on extended reality provided according to one or more examples of the disclosure, under the condition that the selected object is a first audio in the real space,
the step the selected object is added to the target position in response to a second gesture operation includes: attribute information of a first object that is related to the first audio in the extended reality space is determined based on the target position; and
the first audio is played based on the attribute information of the first object by taking the target position as a sound source position; where
an audio effect of the first audio is related to the attribute information of the first object.

In the controlling method based on extended reality provided according to one or more examples of the disclosure, the attribute information of the first object that is related to the first audio in the extended reality space includes any one of the following:
an environmental attribute of an environment where the target position is located in the extended reality space;
a material attribute and/or a thing type attribute of a thing where the target position is located; and
an emotional attribute and/or a biological species attribute of a creature where the target position is located.

According to one or more examples of the disclosure, a controlling apparatus based on extended reality is provided. The controlling apparatus based on extended reality includes:
an obtaining unit configured to determine a first audio in a real space in response to a first operation event of a current user; and
a controlling unit configured to determine a first position in an extended reality space in response to a second operation event of the current user; where
the controlling unit is further configured to play the first audio by taking the first position as a sound source position of the first audio in the extended reality space.

According to one or more examples of the disclosure, a controlling apparatus based on extended reality is provided. The controlling apparatus based on extended reality includes:
an obtaining unit configured to determine a first audio in a real space in response to a first operation event of a current user; and
a controlling unit configured to determine a first position in an extended reality space in response to a second operation event of the current user; where
the controlling unit is further configured to play the first audio by taking the first position as a sound source position of the first audio in the extended reality space.

According to one or more examples of the disclosure, an electronic device is provided. The electronic device includes: at least one processor and at least one memory, where
the at least one memory is configured to store program codes, and the at least one processor is configured to execute any method described above by calling the program codes stored in the at least one memory.

According to one or more examples of the disclosure, a computer-readable storage medium is provided. The computer-readable storage medium is configured to store program codes, where the program codes are configured to cause a processor to execute the method described above when run by the processor.

What is described above is merely description of preferred examples of the disclosure and applied technical principles. It should be understood by those skilled in the art that the disclosed scope involved in the disclosure is not limited to the technical solution formed by a specific combination of the technical features described above, but further covers other technical solution formed by any random combination of the technical features described above or their equivalent features without departing from the concepts described above of the disclosure, for example, a technical solution formed by interchanging the features described above and (non-limitative) technical features having similar functions as disclosed in the disclosure.

In addition, although the operations are depicted in a particular order, it should not be understood that these operations are required to be executed in the particular order shown or in a sequential order. In certain circumstances, multi-task and parallel processing can be advantageous. Similarly, although several specific implementation details are included in the discussion described above, these details should not be construed as limitation to the scope of the disclosure. Some features described in the context of a separate example can be further implemented in a single example in a combination manner. On the contrary, various features described in the context of a single example can be further implemented in a plurality of examples separately or in any suitable sub-combination manner.

Although the subject matter has been described in a language specific to structural features and/or methodological logical actions, it should be understood that the subject matter defined in the appended claims is not necessarily limited to the specific features or actions described above. On the contrary, the specific features and actions described above are merely illustrative implementation forms of the claims.

I/We claim:

1. A controlling method based on extended reality, comprising:
determining a first audio in a real space in response to a first operation event of a current user;
determining a first position in an extended reality space in response to a second operation event of the current user; and
playing the first audio by taking the first position as a sound source position of the first audio in the extended reality space.

2. The method of claim 1, wherein the playing the first audio by taking the first position as a sound source position of the first audio in the extended reality space comprises:
determining, based on the first position, attribute information of a first object that is related to the first audio in the extended reality space; and
playing the first audio based on the attribute information of the first object by taking the first position as the sound source position;
wherein an audio effect of the first audio is related to the attribute information of the first object.

3. The method of claim 2, wherein the attribute information of the first object that is related to the first audio in the extended reality space comprises at least one of:
an environmental attribute of an environment where the first position in the extended reality space is located;
a material attribute and/or a thing type attribute of a thing where the first position is located; and
an emotional attribute and/or a biological species attribute of a creature where the first position is located.

4. The method of claim 1, wherein after the determining a first audio in a real space and before responding to a second operation event of the current user, the method further comprises:
removing, from the first audio, an interfering sound or an audio of an object specified by the current user by filtering the determined first audio in the real space.

5. The method of claim 1, wherein before the determining a first audio in a real space in response to a first operation event of a current user, the method further comprises:
obtaining an image of the real space, and generating a point cloud map based on the image of the real space; and
calibrating the real space based on the point cloud map, and determining corresponding coordinates of a thing in the real space in the extended reality space.

6. The method of claim 1, wherein the determining a first audio in a real space in response to a first operation event of a current user comprises:
determining a target object in the real space in response to at least one of an eye fixation operation, a gesture operation or a voice operation by the current user, and determining the first audio based on the target object.

7. The method of claim 6, wherein the determining a target object in the real space in response to at least one of an eye fixation operation, a gesture operation or a voice operation by the current user comprises:
determining, in response to the eye fixation operation by the current user, scores of individual second objects at which the current user glances, and determining the target object based on the scores of the individual second objects at which the current user glances; wherein the score of the second object changes as the current user looks at the second object or looks away from the second object; or
determining, in response to the voice operation or the gesture operation by the current user, an object under a current gaze through the eye fixation operation by the current user as the target object in a case that a meaning of the voice operation or the gesture operation indicates that the current user is to determine the target object.

8. The method of claim 1, further comprising:
determining a first image or a first text in the real space in response to a third operation event of the current user;
determining a second position in the extended reality space in response to a fourth operation event of the current user; and
displaying the first image or the first text at the second position of the extended reality space.

9. The method of claim 1, further comprising:
controlling a virtual thing to execute a corresponding response action in response to determining that the virtual thing in the extended reality space is in contact with an physical thing in the real space.

10. A controlling method based on extended reality, comprising:
determining a selected object in a real space in response to a first gesture operation;
determining a target position in an extended reality space based on a line of sight of a current user; and
adding the selected object to the target position in response to a second gesture operation.

11. The method of claim 10, wherein,
the selected object comprises one or more of an audio, a picture, a text or a thing.

12. The method of claim 10, wherein,
the selected object is a first audio in the real space;
the adding the selected object to the target position in response to a second gesture operation comprises: determining, based on the target position, attribute information of a first object that is related to the first audio in the extended reality space; and
playing the first audio based on the attribute information of the first object by taking the target position as a sound source position;
wherein an audio effect of the first audio is related to the attribute information of the first object.

13. The method of claim 12, wherein the attribute information of the first object that is related to the first audio in the extended reality space comprises any one of the following:
an environmental attribute of an environment where the target position in the extended reality space is located;
a material attribute and/or a thing type attribute of a thing where the target position is located; and
an emotional attribute and/or a biological species attribute of a creature where the target position is located.

14. An electronic device, comprising:
at least one processor;
at least one memory configured to store program codes,
wherein the program codes, when executed by the at least one processor, cause the at least one processor to:
determine a first audio in a real space in response to a first operation event of a current user;
determine a first position in an extended reality space in response to a second operation event of the current user; and
play the first audio by taking the first position as a sound source position of the first audio in the extended reality space.

15. The electronic device of claim 14, wherein the playing the first audio by taking the first position as a sound source position of the first audio in the extended reality space comprises:
determining, based on the first position, attribute information of a first object that is related to the first audio in the extended reality space; and
playing the first audio based on the attribute information of the first object by taking the first position as the sound source position;
wherein an audio effect of the first audio is related to the attribute information of the first object.

16. The electronic device of claim 14, wherein after the determining a first audio in a real space and before responding to a second operation event of the current user, the method further comprises:
removing, from the first audio, an interfering sound or an audio of an object specified by the current user by filtering the determined first audio in the real space.

17. The electronic device of claim 14, wherein before the determining a first audio in a real space in response to a first operation event of a current user, the method further comprises:
obtaining an image of the real space, and generating a point cloud map based on the image of the real space; and
calibrating the real space based on the point cloud map, and determining corresponding coordinates of a thing in the real space in the extended reality space.

18. The electronic device of claim 14, wherein the determining a first audio in a real space in response to a first operation event of a current user comprises:
determining a target object in the real space in response to at least one of an eye fixation operation, a gesture operation or a voice operation by the current user, and determining the first audio based on the target object.

19. The electronic device of claim 14, the at least one processor is further caused to:
determine a first image or a first text in the real space in response to a third operation event of the current user;
determine a second position in the extended reality space in response to a fourth operation event of the current user; and
display the first image or the first text at the second position of the extended reality space.

20. The electronic device of claim 14, the at least one processor is further caused to:
control a virtual thing to execute a corresponding response action in response to determining that the virtual thing in the extended reality space is in contact with an physical thing in the real space.
